(19) United States
(12) Patent Application Publication
(10) Pub. No.: US 2007/0284154 A1
(43) Pub. Date: Dec. 13, 2007

(54) User Interface Device, Method and the Portable Terminal Thereof

(75) Inventors: Dong Li, League City, TX (US); Jin Guo, Cupertino, CA (US)

Correspondence Address: DONG LI, 2558 COSTA MESA CIRCLE, LEAGUE CITY, TX, 77573, US

(73) Assignees: Dong Li, League City, TX (US); Jin Guo, Cupertino, CA (US)

(21) Appl. No.: 11/659,917

(22) PCT Filed: Aug. 12, 2004
(86) PCT No.: PCT/CN04/00937

§ 371 Date: Feb. 10, 2007

(51) Int. Cl. G06F 3/041

(52) U.S. Cl. 178/18.03; 345/158

(57) ABSTRACT

The present invention provides a user interface device, method and the portable terminal thereof, comprising: a sensing surface, formed by at least one sensing unit; a sensing keypad, formed by at least one sensing key from placing parts on the said sensing surface; a sensing circuit connected to the said sensing surface; the said sensing circuit generates position signal of a sensing object when the sensing object is in effective sensing range of the said sensing surface; the said sensing circuit also reports ON/OFF status signal of the said sensing key. The important benefits of the present invention are: it provides this new handwriting text input function while keeping the original physical size of the mobile handset and original functionality of the digit keypad of the mobile handset intact.

### FIELD OF THE INVENTION

The invention relates generally to the field of electronics technologies, and more particularly, to a sensing keypad as a user interface device, method and the portable terminal thereof.

### BACKGROUND OF THE INVENTION

Mobile handset, as one type of portable terminals, has become popular communication tool for many users with the development of communication technologies. Mobile handsets are evolving towards miniaturization, personalization, differentiation, and data-convergence. Traditional mobile handset is mainly for voice communication, which has a relatively simple requirement for user interface device. Contact switch based mobile handset digit keypad has been adequately meeting this requirement. The digit keypad normally comprises ten “0-9” alphanumeric keys and several function keys. Elastic dome is placed under key. When the key is pressed down, the electrically conductive layer of the inner surface of the dome touches the contact switch beneath to make it switched ON. When push-down force is released from the key, the elastic dome returns to its original position. This mechanism enables a tactile feedback and reminds user that pushing key action is completed. The contact switch technology used in the digit keypad is mature, easy to implement, and reliable. However, as more and more mobile handset users are using mobile handset data communication applications, such as mobile email, instant messaging (IM), and short message services (SMS), text input on mobile handset has presented a new challenging requirement for user interface device. To input text on a traditional mobile handset, especially to input non-alphabetical text such as Chinese, is a very difficult task. Existing user interface device could not meet the requirements as new mobile applications, especially those wireless internet applications based on high-bandwidth GPRS networks, demand for more user input on devices. This deficiency of input technology becomes the bottleneck of wide adoption of wireless internet applications.

Several new user interface devices have been implemented in mobile handset. For example, handwriting recognition powered touch screen has been implemented in mobile handset to input text. There are two types of commonly used touch screens: resistive and capacitive. A resistive touch screen comprises a flexible resistive thin-film and a rigid resistive thin-film with air in the middle to separate these two layers. Its working principle is the following: when a stylus or finger applying force to the touch screen, the top resistive layer bends to the pressure and makes contacts with the bottom resistive layer, and hence closing an electronic circuit indicating the position of the stylus or finger. A capacitive touch screen works similarly, but uses change in capacitance from the pressure applied from the stylus or finger against the touch screen to determine the touch position. However, to keep the overall size small, most of the touch screen mobile handset designs have one touch screen alone but no keypad. User has to use the virtual keypad on the touch screen to dial phone number. Virtual keypad provides no tactile feedback, which is generally acknowledged as very inconvenient and easy to make errors. There are some mobile handsets having both touch screen and keypad, which making them big in size and difficult to carry. In summary, touch screen is difficult to meet the requirements of dialing numbers for a voice call, text input and small size simultaneously.

Recently, touchpad similar to the one used in notebook computer has been implemented in mobile handset. For example, as disclosed in US2003048257, there is a touchpad inside the flip of Nokia 6108 handset. When the flip is closed, user can press keys on the keypad to dial phone numbers. And when opening the flip, there is a touchpad. User can use stylus to enter text on the touchpad. User uses stylus to write text strokes on the touchpad. The IC controller in the mobile handset senses the pressure changes of the moving stylus on the touchpad. The XY coordinates data of the strokes is recorded and sent to handwriting recognition processor. Then those candidate texts closely matching the written strokes will be displayed. User can select and confirm or delete those candidate text displayed using the stylus touching the menu/icon area of the touchpad. However, having physically separated touchpad and keypad increases the cost and size of the mobile handset.

US2003025679 and EP1197835 disclosed similar user interface devices, to improve the design of having both touchpad and digit keypad. A touchpad is placed under the keypad, keypad function is intact, and dialing a number for voice call is very convenient. At the same time, the contact-less touchpad provides handwriting recognition capability to input text on a mobile handset. Contact-less touchpad is thin, therefore, it does not increase the size of the mobile handset. However, combining the touchpad and keypad mechanically is not easy to implement. To keep the contact switch of keypad working, a hole is drilled for each key; thus, when pressing the key, the mechanical pillar of each key can pass the touchpad underneath successfully through the hole to pressure the dome. As the keypad design is different for different mobile phone models, the touchpad with holes needs to be designed differently to fit each mobile phone model accordingly; this increase the complexity and the cost of manufacturing. Contact-less touchpad comprises several X-directional and Y-directional electrical conducting lines; and X-directional and Y-directional electrical conducting lines have to bend over around each hole. Therefore, the contact-less touchpad's performance is affected by this non-linear behavior significantly. Furthermore, each different keypad design for each different mobile handset model causes different curviness and spacing for X-directional and Y-directional electrical conducting lines. Offset is used to solve this problem, which makes the IC of contact-less touchpad complex. Furthermore, IC of contact-less may have to be different for each different mobile handset models, which increases the complexity and cost of manufacturing. To resolve the issue of backlighting, contact-less touchpad may use transparent electrical conducting materials, which further increases the complexity and cost of manufacturing.

U.S. Pat. No. 5,917,906 disclosed a user interface device, to improve the design of having both touchpad and digit keypad. An array of domes and a spacer sheet is placed on touchpad. The spacer sheet has an array of holes matching those domes; the top surface of domes and spacer sheet is relatively flat, with an entry surface marked with keys placed on top of it. When a stylus or a finger pressing the marked keys, dome provides tactile feedback; at the same time, dome contacts touchpad to produce pressure, and key-pressing function is achieved from determining the position of pressure point. When a stylus or a finger slides with force on the entry surface, handwriting recognition function is achieved from determining the trajectory of movement of the pressure points. This design provides handwriting recognition function along with digit keypad function with tactile feedback. However, it has the following drawbacks: firstly, when a stylus or a finger pressing the marked keys, as dome has a sizable area, the contact with the touchpad is not uniform, it is not accurate to determine if the key is pressed or not, this causes errors, which makes the contact force threshold value and dome response point not consistent, therefore, user may be confused with tactile feedback and make errors to determine if the key is pressed successfully or not; secondly, although the entry surface can be make relatively flat, the pressure points are still not uniform due to the existence of domes, which makes handwriting feel not smooth, the non-uniform of pressure point trajectory reduces the handwriting recognition rate; thirdly, domes and touchpad make contacts directly, the frequent deformation of domes and movement may causes wear of the touchpad.

### SUMMARY OF THE INVENTION

The object of the present invention is to provide a user interface device, method and the portable terminal thereof, which provides this new text input function while keeping the original physical size of the mobile handset and original functionality of the digit keypad of the mobile handset intact.

The present invention teaches a user interface device, comprising: a sensing surface, formed by at least one sensing unit; a sensing keypad, formed by at least one sensing key from placing parts on the said sensing surface; a sensing circuit connected to the said sensing surface; the said sensing circuit generates position signal of a sensing object when the sensing object is in effective sensing range of the said sensing surface; the said sensing circuit also reports ON/OFF status signal of the said sensing key.

The said sensing unit can be capacitive, generating position data through measuring capacitance or change of capacitance of the sensing unit.

The said sensing unit can be resistive, generating position data through measuring resistance or change of resistance of the sensing unit.

The said sensing unit can be inductive, generating position data through measuring inductance or change of inductance of the sensing unit.

The said sensing unit is impedance-based, generating position data through measuring impedance or change of impedance of the sensing unit.

The said sensing key comprising mechanical part with tactile feedback.

The said sensing units are in the same plane.

The said sensing units are in different planes.

The said sensing unit is printed in rectangular, circular, ovular, triangular, polygonal shape or other shapes suitable for sensing.

The same or different shapes of sensing units are printed on the said sensing surface to form a matrix of sensing units.

Each sensing unit is a node of the said matrix.

The sensitivity of the sensing surface is dependent on the density of the said matrix.

The said sensing unit is made of electrically conductive material.

The said sensing unit comprising two sets of electrodes not connected to each other.

The said electrode has a certain width.

The said two sets of electrodes forming coupling capacitance between each other.

The said coupling capacitance changes with the movement of a sensing object within the effective sensing space of the said sensing surface.

Each said electrode is connected to an electrical conducting sheet with a sizable area.

The said electrical conducting sheet is printed in rectangular, circular, ovular, triangular, polygonal shape or other shapes suitable for good electrical conductance and coupling capacitance.

Coupling capacitance is formed between the said electrical conducting sheet and the moving sensing object within the effective sensing space of the said sensing surface.

The said coupling capacitance changes with the movement of a sensing object within the effective sensing space of the said sensing surface.

The said sensing circuit comprising a scan circuit, which can select each sensing unit at a different time sequence.

The said sensing circuit can report the capacitance of the sensing unit and on/off status as a switch of the sensing unit.

The capacitance of the said sensing unit is measured via charge transfer mechanism.

The signal strength of the capacitance of the said sensing unit depends on the number of charge transfer times.

The said sensing surface comprising backlight.

The said sensing keypad formed by at least one sensing key from placing parts on the said sensing surface means: sensing keypad formed by at least one sensing key from placing mechanical parts whose outer surface marked with number, letter or symbol, on the said sensing surface.

The present invention also teaches a portable terminal comprising a user interface device in the keypad area of the portable terminal, wherein the said user interface device, further comprising: a sensing surface, formed by at least one sensing unit; a sensing keypad, formed by at least one sensing key from placing parts on the said sensing surface; a sensing circuit connected to the said sensing surface; the said sensing circuit generates position signal of a sensing object when the sensing object is in effective sensing range of the said sensing surface; the said sensing circuit also reports ON/OFF status signal of the said sensing key.

The said portable terminal is a mobile handset.

The sensing keys with the same number and markings as the standard mobile handset keypad are marked on the said sensing surface of the said portable terminal.

The position data generated by the said sensing circuit when the sensing object moves within the effective sensing space of the said sensing surface, is processed for text input.

The said sensing circuit reporting ON/OFF status of electrical conducting line under the sensing key when the sensing key is pressed, is processed for switch function.

The position data generated by the said sensing circuit when the sensing object moves within the effective sensing space of the said sensing surface, is processed for controlling a cursor on a display of the said portable terminal.

The trajectory of movement of the said sensing object within the effective sensing space of the said sensing surface, is converted to the movement of a cursor on a display of the said portable terminal, therefore controlling the scrolling of menu items.

The present invention also teaches a user interface method, comprising: providing a sensing surface by placing at least one sensing unit in a specific pattern; forming a sensing keypad by arranging at least one sensing key from placing parts on the said sensing surface; connecting a sensing circuit to the said sensing surface; the said sensing circuit generates position signal of a sensing object when the sensing object is in effective sensing range of the said sensing surface; the said sensing circuit also reports ON/OFF status signal of the said sensing key.

The important benefits of the present invention are: it provide a user interface device, method and the portable terminal thereof, which provides this new text input function while keeping the original physical size of the mobile handset and original functionality of the digit keypad of the mobile handset intact.

### BRIEF DESCRIPTION OF THE DRAWINGS

FIG. 1 shows the block diagram of a portable terminal in a preferred embodiment of the invention;

FIG. 2 illustrates a schematic of a preferred embodiment of the invention where the sensing keypad is formed by a matrix of capacitive sensing units;

FIG. 3 illustrates the schematics of three example patterns of a capacitive sensing unit applied in mobile handset;

FIG. 4 is a schematic diagram of a sensing keypad formed by the capacitive sensing units;

FIG. 5 shows an example circuit connection schematic diagram of the capacitive sensing unit matrix connected with the electrical coupling circuit and the microprocessor;

FIG. 6 is a circuit schematic diagram of the electrical coupling circuit of the preferred embodiment of the invention;

FIG. 7 describes the schematic diagram of the measurement circuit of the electrical coupling circuit;

FIG. 8 describes the diagram of capacitive sensing time sequence of the electrical coupling circuit's control signal;

FIG. 9 describes the diagram of ON/OFF switch sensing time sequence of the electrical coupling circuit's control signal;

FIG. 10 illustrates a schematic of a preferred embodiment of the invention where a sensing keypad is formed by a matrix of capacitive sensing unit;

FIG. 11 illustrate a schematic of a printing pattern of capacitive sensing unit applied in mobile handset.

### DESCRIPTION OF THE PREFERRED EMBODIMENTS

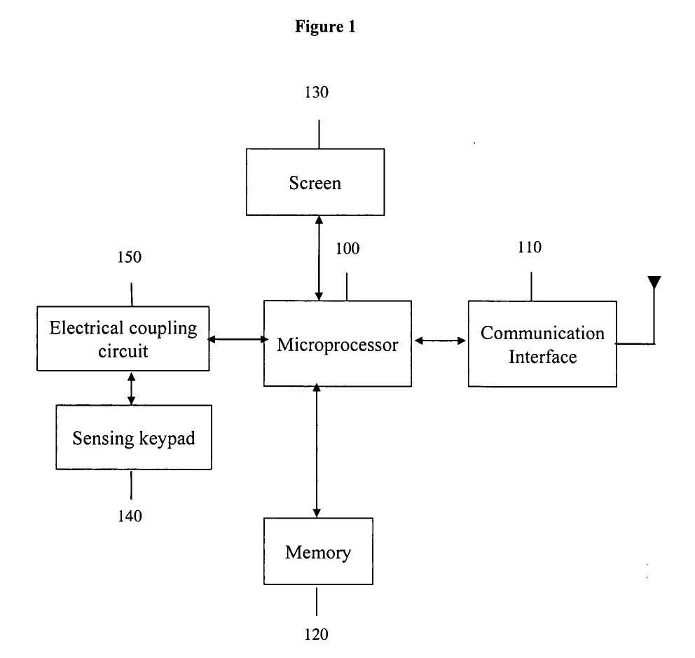

The preferred embodiments are described in detail with drawings. The present invention teaches a user interface device and its portable terminal, and methods of implementing the user interface device. FIG. 1 shows the block diagram of a portable terminal in a preferred embodiment of the invention. The portable terminal comprises of a microprocessor (MCU) 100, a memory 120, a sensing keypad 140, an electrical coupling circuit 150, a screen 130, and a communication interface 110. The screen 130 can be used to display text, symbol or any other information. The communication interface 110 can be any apparatus with a receiver and a transmitter. User can communicate with other portable terminals via the communication interface 110 through, for example, wireless networks.

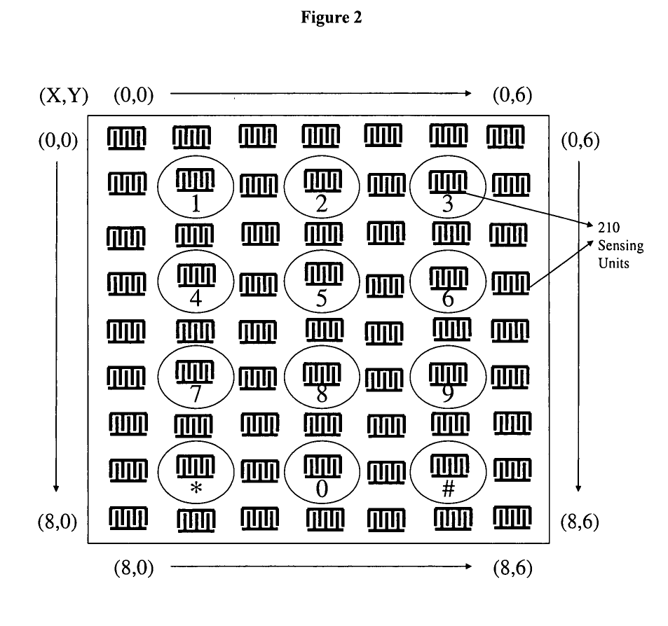

FIG. 2 illustrates a schematic of a preferred embodiment of the invention where the sensing keypad is formed by a matrix of capacitive sensing units; each capacitive sensing unit is printed on a printed circuit board using electrical conductive materials. Each capacitive sensing unit 210 can be formed by a pair of non-connected metal copper lines with a specific pattern. Each capacitive sensing unit is connected with two conductive lines, thereafter referred as X-line and Y-line. FIG. 2 illustrates an example embodiment of a 9×7 matrix; the said capacitive sensing unit matrix could be of other configurations, which is well understood in the field and therefore not discussed in details here. The X-line and Y-line are not connected at the junction. This is achieved by introducing an insulating layer at the junction between X-line and Y-line. This can also be achieved by via technology of drilling holes in the printed circuit board. This via technology is well understood in the printed circuit board field, therefore not further discussed in detail here.

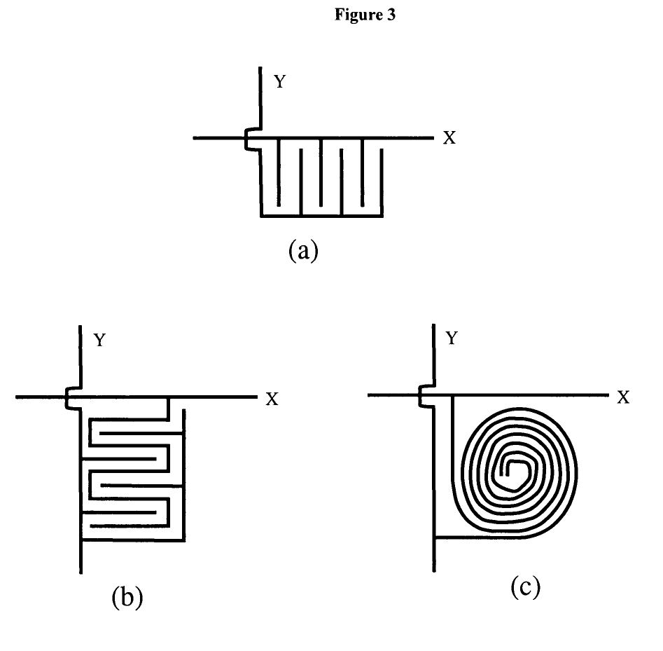

FIG. 3a, FIG. 3b, and FIG. 3c illustrate the schematics of three example patterns of a capacitive sensing unit applied in mobile handset. These patterns have many advantages. In particular, they are easy to be electrically connected with a conductor object on top. They also have good coupling capacitance when the two lines are not connected. The said capacitive sensing unit can be of many other patterns, which is well understood in the field and therefore not discussed in detail here. Each capacitive sensing unit of the preferred embodiment of the invention is printed in the pattern illustrated in the present drawing and forms the capacitive sensing unit matrix of the preferred embodiment of the invention. In normal settings, the two electrical conductive lines are not connected.

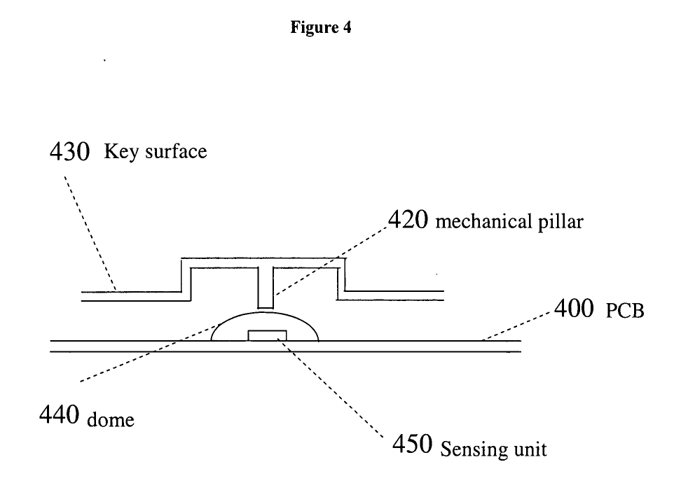

Sensing keypad is formed by placing parts on the capacitive sensing unit matrix. Some of the capacitive sensing units are coupled with mechanical parts with dome. The outer surface of these parts is printed with number and alphanumeric symbols to form sensing keys. A preferred embodiment of the invention is illustrated in FIG. 4. FIG. 4 is a schematic diagram of a sensing keypad formed by the capacitive sensing units. When a sensing object such as finger presses the key placed on top of key mechanical surface 430, the mechanical pillar 420 presses downwards on elastic dome 440, which gives resistance to the downward movement of the finger. The inner surface of dome 440 has an electrically conductive layer. When touching the capacitive sensing unit 210 on the printed circuit board 400; the electrically conductive layer of the dome connects the X-line and Y-line of the capacitive sensing unit and hence closes the said electronic circuit. The electrical coupling circuit 150 and the microprocessor 100 determine that the specific key has been pressed and move on to execute corresponding functions. When the finger pressure is released from the key, the dome 440 pushes the mechanical pillar 420 back to its original position and opens the said electronic circuit. This mechanism enables tactile feedback.

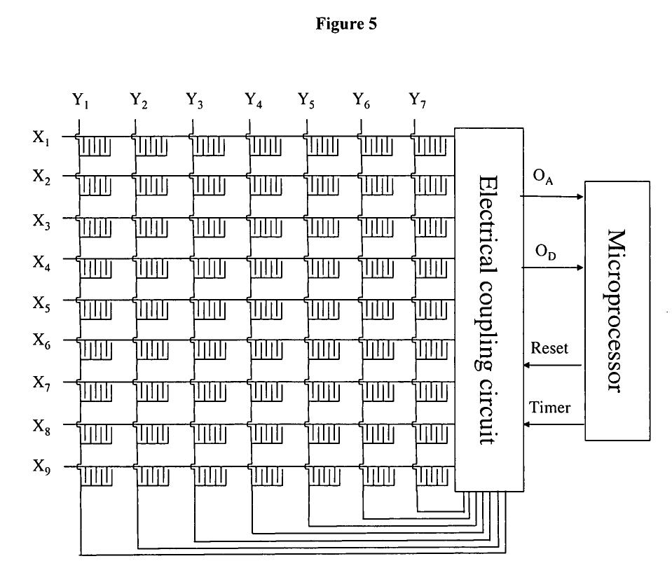

FIG. 5 shows an example circuit connection schematic diagram of the capacitive sensing unit matrix connected with the electrical coupling circuit and the microprocessor; 9 X-lines X1, X2 . . . X9 and 7 Y-lines Y1, Y2 . . . Y7 are connected to the electrical coupling circuit. When a conductive sensing object such as finger is in the proximity of the sensing unit matrix, signals of the electrical sensing circuit are sent to microprocessor 100, preferably in the form of digital signal O_{D} and analog signal O_{A}. The microprocessor controls the electrical coupling circuit using electronic signals, preferably include RESET and TIMER.

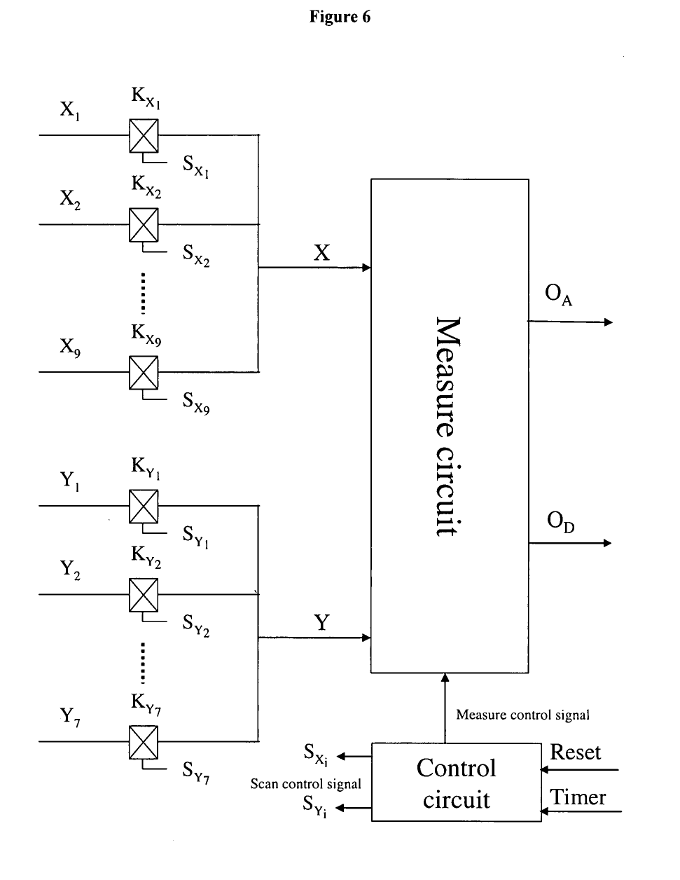

FIG. 6 is a circuit schematic diagram of the electrical coupling circuit of the preferred embodiment of the invention. The electronic coupling circuit comprises a scan circuit, a measurement circuit, and a control circuit. The scan circuit is to select sensing unit one by one accordingly to a defined time sequence. The measurement circuit is to determine one by one switch ON/OFF status and position data of a finger relative to the sensing surface. The control circuit is to control and coordinate the operations. The details of each circuit are further described below.

In FIG. 6, the X-select signals S_{X1}, S_{X2}, . . . , S_{Xn} are to select their corresponding X-lines. The Y-select signals S_{Y1}, S_{Y2}, . . . , S_{Yn} are to select their corresponding Y-lines. K_{X1}, K_{X2} . . . K_{X9} are switches. They can be made of MOSET transistors or some other ways. S_{X1}, S_{X2} . . . S_{X9} are corresponding switch control signals. The principle of Y-select circuit is the same as that of X-select circuit. The time sequence of the scan circuit of the electrical coupling circuit can be typical scan time sequence. This time sequence can be implemented with a counter, or a finite-state-machine, or a microprocessor (MCU).

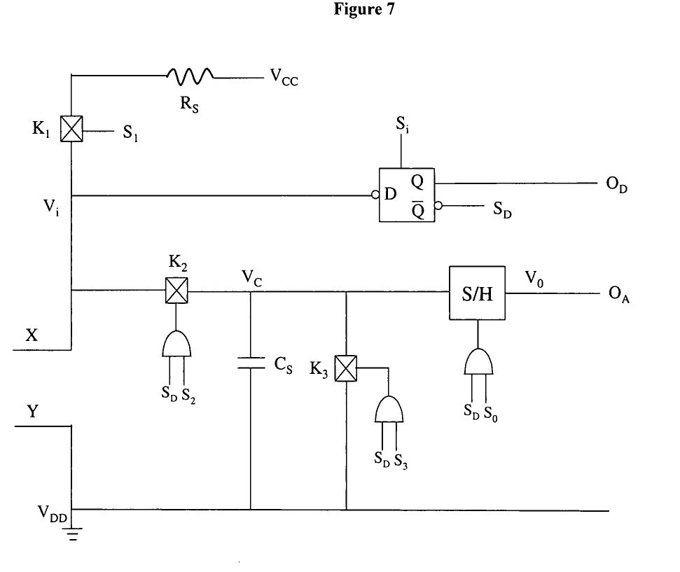

FIG. 7 describes the schematic diagram of the measurement circuit of the electrical coupling circuit. X and Y are outputs from the scan circuit, which corresponds to a specific known sensing unit in a specific time stamp. K₁, K₂, K₃ are three switches. S₁, S₂, S₃ are three corresponding switch control signals. D is a D-type register. Signal Sᵢ controls inputs. S/H is a standard sample-and-hold circuit. This circuit samples at a specific time sequence, and keeps the signal intact until next sampling. Therefore it keeps signal sampled intact during the processing. It is controlled by signal S₀. S_{D} is the reverse-phase output of D-type register. AND gates each controls a switch and corresponding S/H circuit. C_{S} is a system capacitor. R_{S} is a system resister. The parameter value is relatively large. O_{D} is digital output and O_{A} is analog output. V_{CC} is the power source, and V_{DD} is the ground.

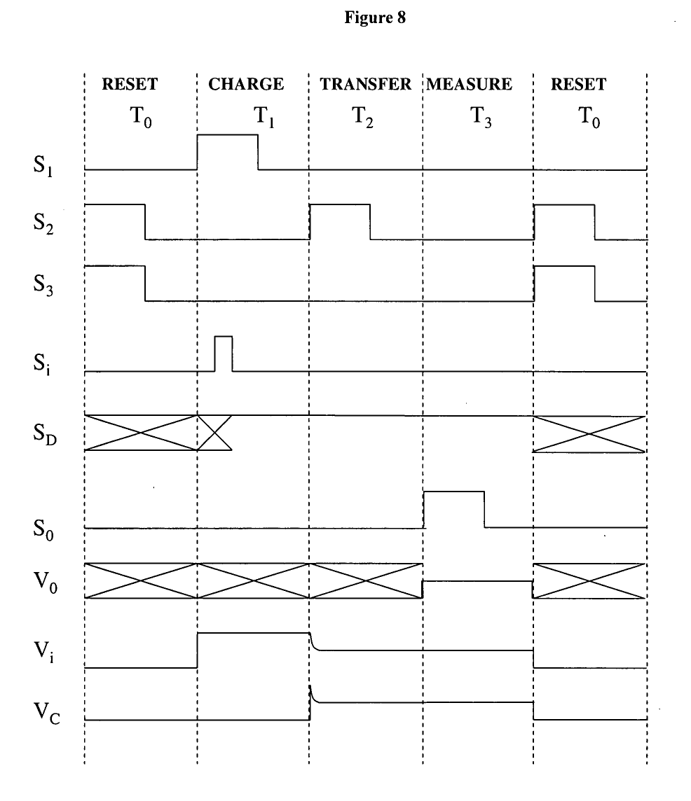

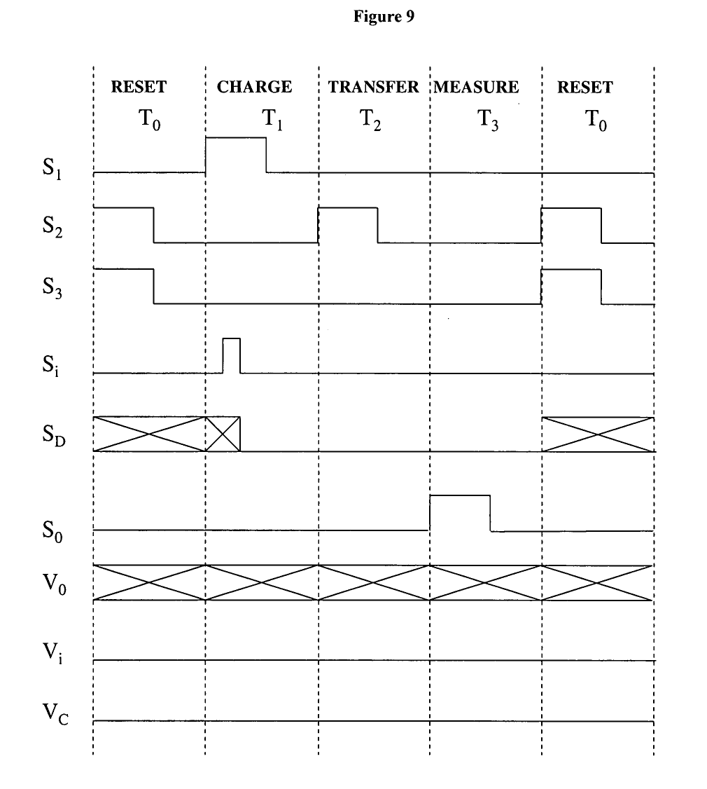

FIG. 8 describes the diagram of capacitive sensing time sequence of the electrical coupling circuit's control signal. FIG. 9 describes the diagram of ON/OFF switch sensing time sequence of the electrical coupling circuit's control signal. Both time sequences each has four phases: RESET, CHARGE, TRANSFER, and MEASURE. RESET is to clear charges in C_{S} and C_{XY}. C_{XY} is the coupling capacitance between the X-line and Y-line of a sensing unit. If S_{D}=0, it means that X-line and Y-line are connected last time, and hence C_{XY} and C_{S} are already cleared so this step need not to be repeated. If S_{D}=1, it means that X-line and Y-line are not connected last time. In this case, the capacitive sensing time sequence is applied with switch K₂ and K₃ closed, which means X and C_{S} are connected to ground, and all residual charge is cleared. The CHARGE phase is to charge coupling capacitor C_{XY}. Resister R_{S} is added to prevent short circuit as X-line and Y-line may be connected to ground. After S₁ signal is sent, switch K₁ is closed (connected). If X-line and Y-line are not connected, V_{CC} does not form a closed circuit, and hence Vᵢ=V_{CC}. Hence the coupling capacitor between X-line and Y-line is charged. If X-line and Y-line are connected, we have Vᵢ=V_{DD} (ground). No matter connected or not, after switch K₁ is closed, a short PULSE is sent to push Vᵢ into D-type register. During TRANSFER phase, if X-line and Y-line are not connected, we have Vᵢ=V_{CC} and S_{D}=1. All switches function normally. Then switch K₂ is closed and switch K₁ is open, transferring the charge from capacitor C_{XY} to the large system capacitor C_{S}. If X-line and Y-line are connected, we have Vᵢ=V_{DD} (ground). Thus SD=0. All the switches do not function, and hence there is no change. During MEASURE phase, if X-line and Y-line are not connected, signal S₀ is sent and V_{CC} is applied to the SAMPLE-AND-HOLD circuit and the result as the system analog output O_{A} is reported to microprocessor (MCU). Otherwise there is no change. Above steps are repeated for each sensing unit. The net results are: if X-line and Y-line are not connected, we have O_{D}=1 and O_{A}=position of finger; if X-line and Y-line are connected, we have O_{D}=0 and O_{A}=NO CHANGE. These components can be integrated into a single circuit.

In summary, a sensing keypad is formed by placing mechanical parts on a capacitive sensing unit matrix. Only some of the capacitive sensing units are coupled with mechanical parts with dome. The outer surface of these mechanical parts is printed with number and alphanumeric symbols to form sensing keys. When a sensing object such as finger presses a key placed on top of key mechanical surface 430, the mechanical pillar 420 presses downwards on dome 440, which gives resistance to the downward movement of the finger. The inner surface of dome 440 is printed with electrically conductive layer, which touches the capacitive sensing unit 210 on the printed circuit board 400 and closes the electronic circuit of the X-line and Y-line of the capacitive sensing unit. Applying a scanning time sequence, the electrical coupling circuit 150 and the microprocessor 100 can determine which specific key has been pressed and hence execute corresponding functions. When the finger pressure is released from the key, the dome 440 pushes the mechanical pillar 420 back to its original position. This mechanism enables tactile feedback.

On the other hand, when a conductive sensing object such as finger slides on the sensing keypad, the electrical coupling circuit reports the capacitance of each sensing unit to the microprocessor (MCU). The position of the finger at a specific time is then calculated with a weighting and interpolation algorithm to determine the center of the capacitance change of each sensing unit. Multidimensional coordinate data is generated from the trajectory of finger movement by the sensing unit. The microprocessor 100 with handwriting recognition software processes the multidimensional coordinate data and generates a plural of candidate text of the desired text, and display the selected desired text on the screen of the portable terminal.

The second preferred embodiment of the present invention is described below along with corresponding drawings.

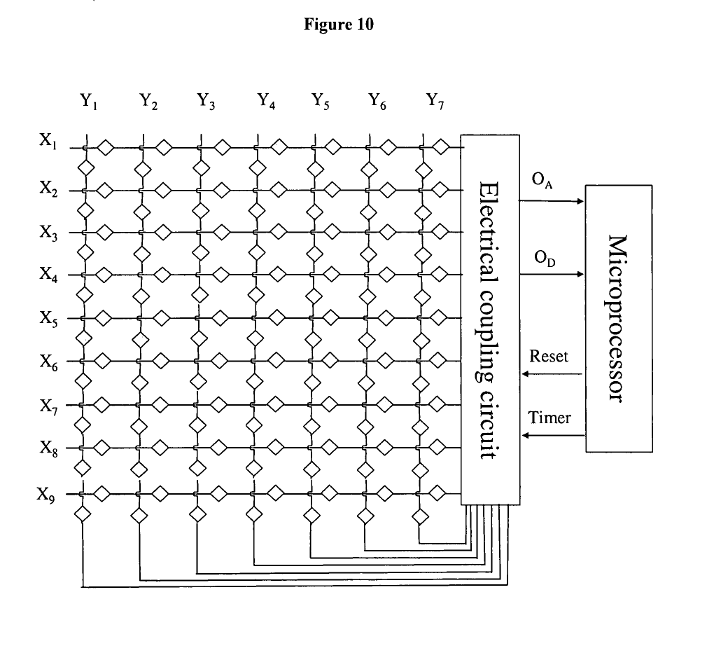

FIG. 10 illustrates a schematic of a preferred embodiment of the invention where a sensing keypad is formed by a matrix of capacitive sensing unit; each capacitive sensing unit is printed on the printed circuit board using electrical conductive materials. For example, each capacitive sensing unit can be formed by a string of conductive snippets in a specific pattern. The capacitive sensing units are generally arranged along two directions, such as horizontal X directions with X-lines and vertical Y directions with Y-lines. The two directions of capacitive sensing units form capacitive sensing matrix. FIG. 10 illustrates an example of a 9×7 matrix. The said capacitive sensing matrix could be of other dimensions, which is well understood in the field and therefore not discussed in detail here. X-lines and Y-lines are not connected at the junction. This is achieved by a insulating layer at the junction between X-lines and Y-lines. This can also be achieved by via technology of drilling holes in the printed circuit board. This via technology is well understood in the printed circuit board field and therefore not discussed in detail here.

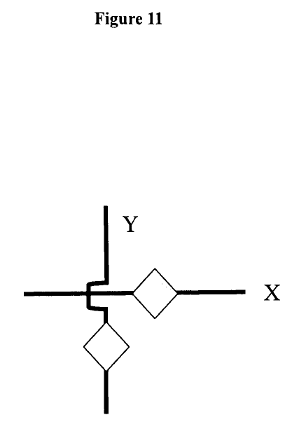

FIG. 11 illustrate a schematic of a printing pattern of capacitive sensing unit applied in mobile handset. It comprises of two diamond-shaped conductive snippets, respectively connected to an X-line and a Y-line. This pattern has many advantages. In particular, they are easy to be electrically connected with a conductor object on top. They also have good coupling capacitance when the two are not connected. The said capacitive sensing unit can be of other patterns, which are well understood in the field and therefore not discussed in detail here. Each capacitive sensing unit of the preferred embodiment of the invention is printed in the pattern illustrated in the present drawing. This forms the capacitive sensing matrix of the preferred embodiment of the invention. In normal settings, the two electrical conductive lines are not connected.

Some of the capacitive sensing units are coupled with mechanical parts with dome. The outer surface of these mechanical parts is printed with number and alphanumeric symbols to form sensing keys. The details of this part of the present embodiment are the same as those described in the previous embodiment in the above paragraphs.

When a finger presses the key placed on top of key mechanical surface 430, the mechanical pillar 420 presses downwards on elastic dome 440, which gives resistance to the downward movement of the finger. The inner surface of dome 440 has an electrically conductive layer. When touching the capacitive sensing unit 210 on the printed circuit board 400; the electrically conductive layer of the dome connects the X-line and Y-line of the capacitive sensing unit and hence closes the said electronic circuit. The electrical coupling circuit 150 and the microprocessor 100 determine that the specific key has been pressed and move on to execute corresponding functions. When the finger pressure is released from the key, the dome 440 pushes the mechanical pillar 420 back to its original position and opens the said electronic circuit. This mechanism enables tactile feedback.

On the other hand, when a conductive sensing object such as finger slides on the sensing keypad, the electrical coupling circuit reports the capacitance of each sensing unit to the microprocessor (MCU). The position of the finger at a specific time is then calculated with a weighting and interpolation algorithm to determine the center of the capacitance change of each sensing unit. Multidimensional coordinate data is generated from the trajectory of finger movement by the sensing unit. The microprocessor 100 with handwriting recognition software processes the multidimensional coordinate data and generates a plural of candidate text of the desired text, and display the selected desired text on the screen of the portable terminal. The electrical coupling circuit and its connection to microprocessor part of the present embodiment is the same as those described in the previous embodiment.

The important benefits of the present invention are: it enables new finger touch sensing and writing text input capabilities while maintaining the original mechanical aspects of a mobile handset and preserving original behavior of a normal mechanical digit keypad. In addition, it reduces material cost of a mobile handset.

While embodiments and applications of this invention have been shown and described, it would be apparent to those skilled in the art that many more modifications and changes than mentioned above are possible without departing from the inventive concepts herein. This invention, therefore, is not to be restricted.

1. A user interface device, comprising:
A sensing surface, formed by at least one sensing unit;
A sensing keypad, formed by at least one sensing key from placing parts on the said sensing surface;
A sensing circuit connected to the said sensing surface;
The said sensing circuit generates position signal of a sensing object when the sensing object is in effective sensing range of the said sensing surface;
The said sensing circuit also reports ON/OFF status signal of the said sensing key.

2. A device of claim 1, wherein the said sensing unit can be capacitive, generating position data through measuring capacitance or change of capacitance of the sensing unit.

3. A device of claim 1, wherein the said sensing unit can be resistive, generating position data through measuring resistance or change of resistance of the sensing unit.

4. A device of claim 1, wherein the said sensing unit can be inductive, generating position data through measuring inductance or change of inductance of the sensing unit.

5. A device of claim 1, wherein the said sensing unit is impedance-based, generating position data through measuring impedance or change of impedance of the sensing unit.

6. A device of claim 1, wherein the said sensing key comprising mechanical part with tactile feedback.

7. A device of claim 1, wherein the said sensing units are in the same plane.

8. A device of claim 1, wherein the said sensing units are in different planes.

9. A device of claim 1, wherein the said sensing unit is printed in rectangular, circular, ovular, triangular, polygonal shape or other shapes suitable for sensing.

10. A device of claim 9, wherein the same or different shapes of sensing units are printed on the said sensing surface to form a matrix of sensing units.

11. A device of claim 10, wherein each sensing unit is a node of the said matrix.

12. A device of claim 10, wherein the sensitivity of the sensing surface is dependent on the density of the said matrix.

13. A device of claim 1, wherein the said sensing unit is made of electrically conductive material.

14. A device of claim 1, wherein the said sensing unit comprising two sets of electrodes not connected to each other.

15. A device of claim 14, wherein the said electrode has a certain width.

16. A device of claim 14, wherein the said two sets of electrodes forming coupling capacitance between each other.

17. A device of claim 14, wherein the said coupling capacitance changes with the movement of a sensing object within the effective sensing space of the said sensing surface.

18. A device of claim 14, wherein each said electrode is connected to an electrical conducting sheet with a sizable area.

19. A device of claim 18, wherein the said electrical conducting sheet is printed in rectangular, circular, ovular, triangular, polygonal shape or other shapes suitable for good electrical conductance and coupling capacitance.

20. A device of claim 19, wherein coupling capacitance is formed between the said electrical conducting sheet and the moving sensing object within the effective sensing space of the said sensing surface.

21. A device of claim 20, wherein the said coupling capacitance changes with the movement of a sensing object within the effective sensing space of the said sensing surface.

22. A device of claim 1, wherein the said sensing circuit comprising a scan circuit, which can select each sensing unit at a different time sequence.

23. A device of claim 1, wherein the said sensing circuit can report the capacitance of the sensing unit and on/off status as a switch of the sensing unit.

24. A device of claim 23, wherein the capacitance of the said sensing unit is measured via charge transfer mechanism.

25. A device of claim 24, wherein the signal strength of the capacitance of the said sensing unit depends on the number of charge transfer times.

26. A device of claim 1, wherein the said sensing surface comprising backlight.

27. A device of claim 1, wherein the said sensing keypad formed by at least one sensing key from placing parts on the said sensing surface means: sensing keypad formed by at least one sensing key from placing mechanical parts whose outer surface marked with number, letter or symbol, on the said sensing surface.

28. A portable terminal comprising a user interface device in the keypad area of the portable terminal, wherein the said user interface device, comprising:
A sensing surface, formed by at least one sensing unit;
A sensing keypad, formed by at least one sensing key from placing parts on the said sensing surface;
A sensing circuit connected to the said sensing surface;
The said sensing circuit generates position signal of a sensing object when the sensing object is in effective sensing range of the said sensing surface;
The said sensing circuit also reports ON/OFF status signal of the said sensing key.

29. An apparatus of claim 28, wherein the said portable terminal is a mobile handset.

30. An apparatus of claim 29, wherein the sensing keys with the same number and markings as the standard mobile handset keypad are marked on the said sensing surface of the said portable terminal.

31. An apparatus of claim 28 or 29 or 30, wherein the position data generated by the said sensing circuit when the sensing object moves within the effective sensing space of the said sensing surface, is processed for text input.

32. An apparatus of claim 28 or 29 or 30, wherein the said sensing circuit reporting ON/OFF status of electrical conducting line under the sensing key when the sensing key is pressed, is processed for switch function.

33. An apparatus of claim 28 or 29 or 30, wherein the position data generated by the said sensing circuit when the sensing object moves within the effective sensing space of the said sensing surface, is processed for controlling a cursor on a display of the said portable terminal.

34. An apparatus of claim 33, wherein the trajectory of movement of the said sensing object within the effective sensing space of the said sensing surface, is converted to the movement of a cursor on a display of the said portable terminal, therefore controlling the scrolling of menu items.

35. A user interface method, comprising:
Providing a sensing surface by placing at least one sensing unit in a specific pattern;
Forming a sensing keypad by arranging at least one sensing key from placing parts on the said sensing surface;
Connecting a sensing circuit to the said sensing surface;
The said sensing circuit generates position signal of a sensing object when the sensing object is in effective sensing range of the said sensing surface;
The said sensing circuit also reports ON/OFF status signal of the said sensing key.
